(19) United States
(12) Patent Application Publication
(10) Pub. No.: US 2013/0144811 A1
(43) Pub. Date: Jun. 6, 2013

(54) SYSTEM AND METHOD FOR COMPUTING A VARIABLE FUEL PRICE BASED ON EXHAUST GAS EMISSIONS OF A VEHICLE

(71) Applicants: Ajith Kumar Padmalayam Narayana Kurup, Bangalore (IN); Shanmugasundaram Murugesan, Bangalore (IN); Gurbrinder Singh Bindra, Bangalore (IN)

(72) Inventors: Ajith Kumar Padmalayam Narayana Kurup, Bangalore (IN); Shanmugasundaram Murugesan, Bangalore (IN); Gurbrinder Singh Bindra, Bangalore (IN)

(21) Appl. No.: 13/816,625

(22) PCT Filed: Aug. 12, 2011
(86) PCT No.: PCT/IN2011/000545

§ 371 Date: Feb. 12, 2013

(30) Foreign Application Priority Data
Aug. 12, 2010 (IN) 2319/CHE/2010

(51) Int. Cl. G06Q 30/02

(52) U.S. Cl. CPC G06Q 30/0206
USPC 705/413

(57) ABSTRACT

The present invention provides a system and method of computing a variable fuel price based on exhaust gas emission of a vehicle. In one embodiment, a system includes an onboard unit fitted in a vehicle for measuring amount of exhaust gas emissions by the vehicle and a remote server communicatively connected to the onboard unit for computing a discount or surcharge on a base fuel price based on the amount of exhaust gas emissions by the vehicle. The system also includes a fuel station communicatively coupled to the remote server for filling fuel in a fuel tank of the vehicle at the discounted or surcharge fuel price.

### RELATED APPLICATION

Benefit is claimed to Indian Provisional Application No. 2319/CHE/2010, titled “SYSTEM AND METHOD OF VARIABLE FUEL PRICING BASED ON EMISSION VALUES OF VEHICLES” by Logica Pvt. Ltd., filed on Aug. 12, 2010, which is herein incorporated in its entirety by reference for all purposes.

### FIELD OF THE INVENTION

The present invention relates to fuel delivery system, and more particularly relates to a system and method of computing price of fuel supplied to a vehicle.

### BACKGROUND OF THE INVENTION

The impact of using fuel such as gasoline, diesel, etc. to run a vehicle is prone to increase global warming due to emission of hazardous exhaust gases such as carbon di-oxide, carbon-monoxide, etc. The hazardous emissions can be lowered by monitoring the emission of exhaust gas and applying corrective measure wherever applicable.

One of the factors that lead to emission of un-burnt exhaust gases is driving behavior. Improper vehicle utilization and imprudent driving behavior may cause increased emission of hazardous exhaust gases and also adversely affect fuel efficiency of the vehicle. The fuel efficiency of the vehicle may be improved and emission of exhaust gases can be significantly lowered if the driving behavior is improved. The driving behavior can be improved by rewarding the driver with good driving habits. At the same time, it is desirable that a driver with imprudent driving habits be penalized to control exhaust gas emission levels.

### SUMMARY OF THE INVENTION

The present invention relates to a system and method for computing variable fuel price based on exhaust gas emissions of a vehicle. In one aspect, a system includes an onboard unit fitted in a vehicle for measuring amount of exhaust gas emissions by the vehicle. Also, the system includes a remote server communicatively connected to the onboard unit for computing a discount or surcharge on a base fuel price based on the amount of exhaust gas emissions by the vehicle. Additionally, the system includes a fuel station communicatively coupled to the remote server for filling fuel in a fuel tank of the vehicle at the discounted or surcharged fuel price.

In another aspect, a method of computing a variable fuel price based on exhaust gas emissions of a vehicle includes measuring amount of exhaust gas emissions by the vehicle using an onboard unit fitted in the vehicle. The method also includes dynamically computing a discount or surcharge on a base fuel price by a remote server based on the measured amount of exhaust gas emissions. Moreover, the method includes computing a final price of fuel to be filled in a fuel tank of the vehicle by a fuel station based on the discount or surcharge value.

In yet another aspect, a system includes an onboard unit fitted in a vehicle for measuring amount of exhaust gas emissions by the vehicle, and computing a discount or surcharge on a base fuel price based on the amount of exhaust gas emissions by the vehicle. The system also includes a fuel station communicatively coupled to the onboard unit for filling fuel in a fuel tank of the vehicle at the discounted or surcharge fuel price.

Other features of the embodiments will be apparent from the accompanying drawings and from the detailed description that follows.

### BRIEF DESCRIPTION OF THE ACCOMPANYING DRAWINGS

FIG. 1 illustrates a block diagram of a fuel pricing system for computing variable fuel price based on exhaust gas emissions by a vehicle, according to one embodiment.

FIG. 2 is a flow diagram of an exemplary method of computing variable fuel price based on exhaust gas emission value of a vehicle, according to one embodiment.

FIG. 3 illustrates a block diagram of a fuel pricing system for computing a variable fuel price based on exhaust gas emissions by a vehicle, according to another embodiment.

The drawings described herein are for illustration purposes only and are not intended to limit the scope of the present disclosure in any way.

### DETAILED DESCRIPTION OF THE EMBODIMENTS OF THE INVENTION

The present invention relates to a system and method for computing variable fuel price based on exhaust gas emissions of a vehicle. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

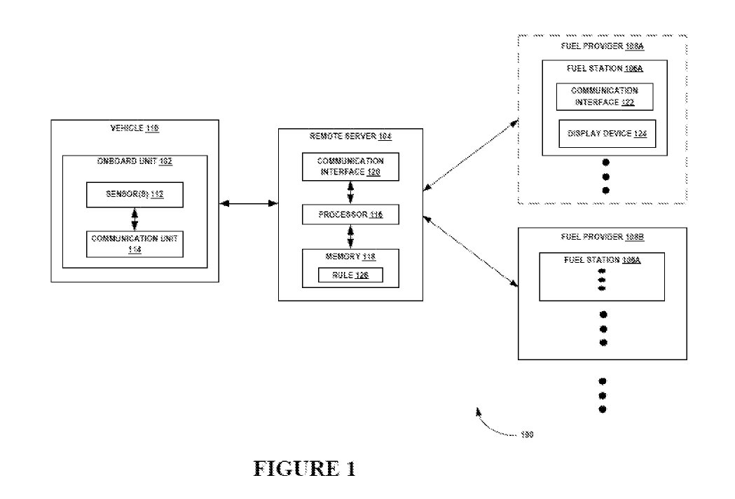

FIG. 1 illustrates a block diagram of a fuel pricing system 100 for computing variable fuel price based on exhaust gas emissions by a vehicle, according to one embodiment. In FIG. 1, the fuel pricing system 100 includes an onboard unit 102, a remote server 104, and a fuel stations 106A-N associated with fuel providers 108A-N.

The onboard unit 102 is a device fitted in a vehicle 110 for monitoring exhaust gas emissions by a vehicle engine (not shown). The onboard unit 102 includes one or more sensors 112 disposed in an exhaust line (not shown) of the vehicle 110 and communication unit 114 wirelessly connected to the remote server 104. The remote server 104 includes a processor 116, memory 118 and communication interface 120. Each of the fuel stations 106A-N also includes a communication interface 122 for communicating with the remote server 104.

In an exemplary operation, when the vehicle engine is ON, sensors 112 in the exhaust line periodically measures amount of exhaust gas emissions by the vehicle engine and communicates to the communication unit 114. The communication unit 114 transfers the measured exhaust gas emission values to the remote server 104 via a communication channel (e.g., Wi-Fi®, GPRS, SMS, and the like).

The processor 116 compares the exhaust gas emission values with a permissible standard exhaust gas emission value in real time and dynamically computes a discount or surcharge on a base fuel price based on a rule 126. For example, the rule 126 may be set as per policy of a fuel company. The rule 126 may indicate that if the measured exhaust gas emission value is greater than the permissible standard exhaust gas emission value, then a surcharge, say 5%, is to be levied on the base fuel price. Alternatively, if the measured exhaust gas emission value is less than the permissible standard exhaust gas emission value, then a discount, say 8%, is to be availed on the base fuel price. The processor 116 computes the discount or surcharge based on the exhaust gas emissions measured from the last fuel filling till the next fuel filling. Thus, the computed discount or surcharge is applicable on the base fuel price for the exhaust gas emissions measured between consecutive filling cycles. The processor 116 stores the discount or surcharge value in the memory 118.

When the vehicle 110 visits a fuel station (say fuel station 106A) for filling fuel, driver provides identification credentials of the vehicle 110 for availing the discount or surcharge on the fuel. The driver may enter the identification details of the vehicle 110 in a data entry equipment connected with the fuel station 106A. For example, the identification credentials may include vehicle number, serial number of the onboard unit 102 fitted in the vehicle 112 or a private key assigned to the vehicle 110. Alternatively, the onboard unit 102 may automatically transfer the identification credentials to the fuel station 106A when the vehicle 110 is parked near to the fuel station 106A.

Accordingly, the communication interface 122 communicates the identification credentials for retrieving the discount/surcharge data computed between the consecutive fuel filling cycles. The processor 116 in the remote server 104 verifies the received identification credentials with information stored in the memory 118 and provides the discount/surcharge data to the fuel station 106A via the communication interface 120. Then, the fuel station 106A computes the final price of a fuel filled/to be filled in a fuel tank of the vehicle 110 based on the discount/surcharge data fetched from the memory 118. In some embodiments, the fuel station 106A computes the final price by applying the discount or surcharge value to the base fuel price.

Alternatively, the processor 116 in the remote server 102 may compute the final fuel price by applying the discount/surcharge on the base fuel price and communicate the final fuel price to the fuel station 106A using the communication interface 120. The final price on the fuel filled/to be filled and discount/surcharge on the base fuel price is displayed on a display device 124 associated with the fuel station 106A. It is appreciated that, the base fuel price is a standard price per unit quantity of fuel set by a government authorities or fuel companies for sale of fuel to customers.

It can be noted that, the remote server 104 may be associated with a third party service provider which provide variable fuel price computation based on exhaust gas emissions as a service to the fuel companies 108A-N. Alternatively, the remote server 104 may be associated with the fuel companies 108A-N deployed from computing variable fuel price based on exhaust gas emissions by vehicles of their customers.

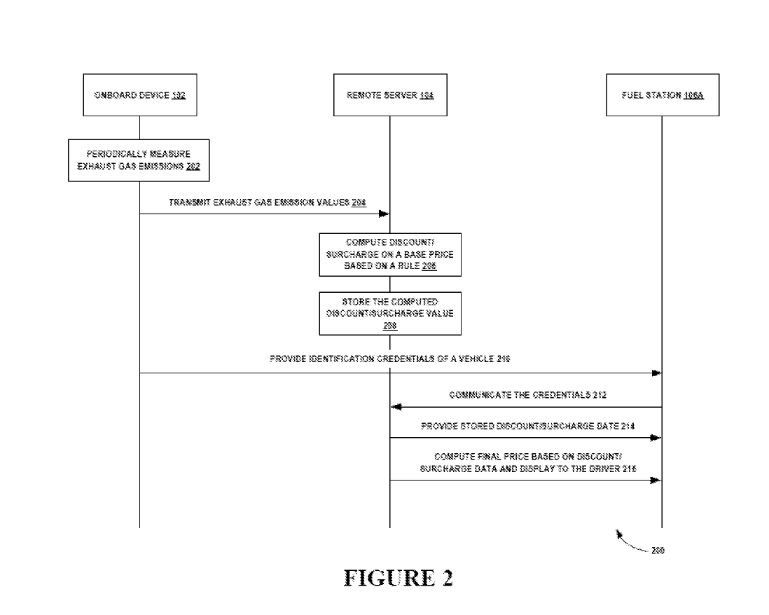

FIG. 2 is a flow diagram 200 of an exemplary method of computing variable fuel price based on exhaust gas emission values of the vehicle 110, according to one embodiment. At step 202, the onboard unit 102 periodically measures amount of exhaust gas emissions by the vehicle engine. At step 204, the onboard unit communicates the measured exhaust gas emissions to the communication unit 114 via a communication channel (e.g., Wi-Fi®, GPRS, SMS, and the like).

At step 206, the remote server 104 computes a discount or surcharge on a base fuel price in real time. The remote server 104 compares the measured exhaust gas emissions with the permissible standard exhaust gas emission value and determines whether to avail a discount or surcharge. In one embodiment, the remote server 104 provides a discount on the base fuel price when the exhaust gas emission value is less than the permissible standard emission value. In an alternate embodiment, the remote server 104 levies a surcharge on the base fuel price when the exhaust gas emission value is greater than the permissible standard emission value.

Further, the remote server 104 computes the discount or surcharge value based on a rule 126. For example, the rule 126 may be set as per policy of a fuel company. The rule 126 may indicate that if the measured exhaust gas emission value is greater than the permissible standard exhaust gas emission value, then a surcharge of say 5% is to be levied on the base fuel price. Alternatively, if the measured exhaust gas emission value is less than the permissible standard exhaust gas emission value, then a discount of say 8% is to be availed on the base fuel price. At step 208, the remote server 104 stores the discount or surcharge value in the memory 118.

When the vehicle 110 visits a fuel station (say fuel station 106A) for filling fuel, the onboard unit 102 provides identification credentials of the vehicle 110 for availing the discount or surcharge on the fuel, at step 210. For example, the identification credentials may include vehicle number, serial number of the onboard unit 102 fitted in the vehicle 112 or a private key assigned to the vehicle 110. At step 212, the fuel station 106A communicates the identification credentials for retrieving the discount/surcharge data computed between the consecutive fuel filling cycles. At step 214, the remote server 104 provides the discount/surcharge data to the fuel station 106A via the communication interface 120 based on the identification credentials. At step 216, the fuel station 106A computes the final price of a fuel filled/to be filled in a fuel tank of the vehicle 110 by applying the received discount or surcharge value to the base fuel price.

For example, consider that the standard fuel price is INR 70.00 per unit of fuel. The average exhaust gas emission values measured by the onboard unit 102 between consecutive fuel filling cycles for the vehicle 110 is 10% higher compared to the permissible standard exhaust gas emission values. Based on the measured emission values, the remote server 102 levies a surcharge of 2% as per the rule 126 defined by the fuel company and calculates the final price for fuel sold to the vehicle 110 as standard price+2% of base fuel price=INR 70.00+INR 1.40=INR 71.40.

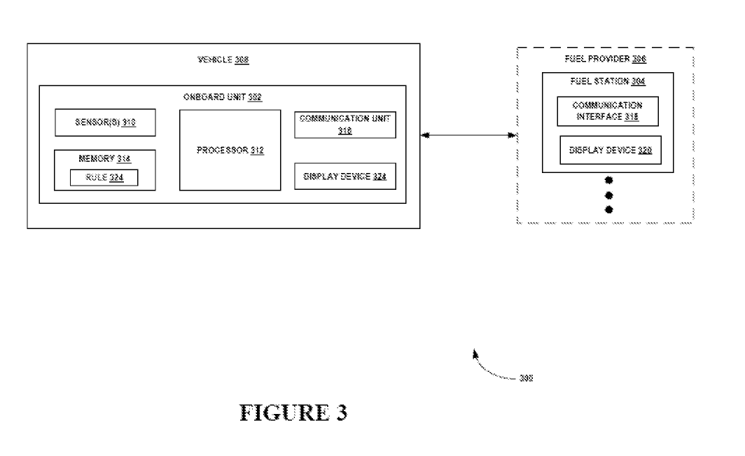

FIG. 3 illustrates a block diagram of a fuel pricing system 300 for computing variable fuel price based on exhaust gas emissions by a vehicle, according to another embodiment. In FIG. 3, the fuel pricing system 300 includes an onboard unit 302, and a fuel station 304 associated with fuel providers 306.

The onboard unit 302 is a device fitted in a vehicle 308 for monitoring exhaust gas emissions by a vehicle engine (not shown). The onboard unit 302 includes one or more sensors 310 disposed in an exhaust line (not shown) of the vehicle 308, a processor 312, memory 314 and a communication unit 316. The fuel station 304 includes a communication interface 318 for communicating with the onboard unit 302.

In an exemplary operation, when the vehicle engine is ON, the sensors 310 disposed in the exhaust line periodically senses amount of exhaust gas emissions by the vehicle engine and provides the measured values to the processor 312. The processor 312 compares the exhaust gas emission values with a permissible standard exhaust gas emission value in real time and dynamically computes discount or surcharge on a base fuel price based on a rule 324 stored in the memory 314. The rule 324 may indicate that if the measured exhaust gas emission value is greater than the permissible standard exhaust gas emission value, then a surcharge of say 5% is to be levied on the base fuel price. Alternatively, if the measured exhaust gas emission value is less than the permissible standard exhaust gas emission value, then a discount of say 8% is to be availed on the base fuel price. In some embodiments, the rule 324 may be set as per policy of a fuel company. In these embodiments, the fuel company may wirelessly configure (e.g., preset) the rule 324 for computing discount/surcharge in the memory 314 of the onboard unit 302 via a remote server. It can be noted that, the onboard unit 302 is designed to be tamper proof so that no one can alter the rule 324 or data stored therein, except the fuel company.

Further, the processor 312 computes the discount or surcharge based on the exhaust gas emissions measured from the last fuel filling till the next fuel filling. Thus, the computed discount or surcharge is applicable on the base fuel price for the exhaust gas emissions measured between consecutive filling cycles. The processor 312 stores the discount or surcharge value in the memory 314. The onboard unit 302 also includes a display device 324 for displaying discount/surcharge applicable on the base fuel price based on the exhaust gas emissions measured from the previous fuel filling as well as price per unit fuel upon considering the discount/surcharge.

During the next fuel filling cycle, the communication unit 316 transfers the discount/surcharge data stored in the memory to the fuel station 304 along with identification credentials (optional) via communication channel such as SMS, GPRS, Wifi®, Zigbee®, Bluetooth®. The identification credentials may include vehicle number, serial number of the onboard unit 302 fitted in the vehicle 308 or a private key assigned to the vehicle 308. Alternatively, the fuel station 304 can fetch the discount/surcharge data from the memory 314 of the onboard unit 302 using the communication interface 318. The fuel station 304 verifies the identification credentials of the vehicle 308 and computes the final price of fuel filled/to be filled in a fuel tank of the vehicle 110 based on the discount/surcharge data fetched from the memory 118. In some embodiments, the fuel station 304 computes the final price by applying the discount or surcharge value to the base fuel price. In these embodiments, the final price on the fuel filled/to be filled and discount/surcharge on the base fuel price is displayed on a display device 320 associated with the fuel station 304.

In various embodiments, the systems and methods described in FIGS. 1 through 3 computes discount or surcharge value applicable on a standard or base fuel price in real time purely based on the exhaust gas emissions by a vehicle and does not consider other factors such as weight, category, mileage, type of vehicle while computing surcharge and discount value.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

1. A system comprising:
an onboard unit fitted in a vehicle for measuring amount of exhaust gas emissions by the vehicle in real time;
a remote server communicatively connected to the onboard unit for computing a discount or surcharge on a base fuel price based on the amount of exhaust gas emissions by the vehicle; and
a fuel station communicatively coupled to the remote server for filling fuel in a fuel tank of the vehicle at the discounted or surcharged fuel price.

2. The system of claim 1, wherein the onboard unit comprises:
at least one sensor deployed in an exhaust line of the vehicle for sensing the exhaust gas emissions by the vehicle; and
a communication unit communicatively coupled to the remote server for periodically transmitting the exhaust gas emission values to the remote server via a communication channel.

3. The system of claim 2, wherein the remote server comprises:
a processor for computing a discount or surcharge on the base fuel price in real time based on the measured exhaust gas emissions; and
memory for storing the discount or surcharge on the base fuel price.

4. The system of claim 3, wherein the processor computes the discount or surcharge based on the exhaust gas emissions measured between consecutive fuel filling cycles.

5. The system of claim 4, wherein the processor computes the discount or surcharge on the base fuel price by comparing the exhaust gas emission value with a permissible standard exhaust gas emission value.

6. The system of claim 5, wherein the processor computes the discount on the base fuel price when the exhaust gas emission value is less than the permissible standard exhaust gas emission value.

7. The system of claim 6, wherein the processor computes a surcharge on the base fuel price when the exhaust gas emission value is greater than the permissible standard exhaust gas emission value.

8. The system of claim 7, wherein the processor computes the discount or surcharge on the base fuel price based on a preset rule, wherein the rule indicate percentage of discount or surcharge applicable on the base fuel price.

9. The system of claim 1, wherein the fuel station is configured for fetching the stored discount or surcharge value from the remote server in real time based on identification credentials associated with the vehicle.

10. The system of claim 9, wherein the fuel station is configured for computing a final price of the fuel to be filled in the fuel tank by applying the fetched discount or surcharge value to the base fuel price.

11. The system of claim 3, wherein the processor is configured for:
computing a final price of the fuel to be filled in the fuel tank by applying the discount or surcharge value to the base fuel price; and
communicating the final price of fuel to be filled in the fuel tank to the fuel station.

12. A method of computing a variable fuel price based on exhaust gas emissions of a vehicle, the method comprising:
measuring amount of exhaust gas emissions by the vehicle in real time using an onboard unit fitted in the vehicle;
dynamically computing a discount or surcharge on a base fuel price by a remote server based on the measured amount of exhaust gas emissions; and
computing a final price of fuel to be filled in a fuel tank of the vehicle by a fuel station based on the discount or surcharge value.

13. The method of claim 12, wherein measuring the amount of exhaust gas emissions by the vehicle comprises:
sensing the exhaust gas emissions by the vehicle using at least one sensor; and
periodically transmitting the exhaust gas emission value to the remote server via a communication channel using a communication unit.

14. The method of claim 12, wherein dynamically computing the discount or surcharge on the base fuel price using the remote server based on the measured amount of exhaust gas emissions comprises:
comparing the exhaust gas emission value with a permissible standard exhaust gas emission value;
computing a discount or surcharge on the base fuel price in real time based on the outcome of comparison; and
storing the discount or surcharge computed on the base fuel price.

15. The method of claim 14, wherein the discount or surcharge on the base fuel price is computed based on the exhaust gas emissions measured between consecutive fuel filling cycles.

16. The method of claim 15, wherein the discount is availed on the base fuel price when the exhaust gas emission value is less than the permissible standard exhaust gas emission value.

17. The method of claim 16, wherein the surcharge amount is levied on the base fuel price when the exhaust gas emission value is greater than the permissible standard gas emission value.

18. The method of claim 17, wherein the discount or surcharge on the base fuel price is computed based on a preset rule, wherein the rule indicate percentage of discount or surcharge applicable on the base fuel price.

19. The method of claim 12, wherein computing the final price of the fuel to be filled in the fuel tank by the fuel station based on the discount or surcharge value comprises:
fetching the discount or surcharge value from the remote server in real time based on identification credentials associated with the vehicle; and
computing the final price of the fuel to be filled in the fuel tank by the fuel station based on the fetched discount or surcharge value.

20. A system comprising:
an onboard unit fitted in a vehicle for:
measuring amount of exhaust gas emissions by the vehicle in real time; and
computing a discount or surcharge on a base fuel price based on the amount of exhaust gas emissions by the vehicle; and
a fuel station communicatively coupled to the onboard unit for filling fuel in a fuel tank of the vehicle at the discounted or surcharge fuel price.

21. The system of claim 20, wherein the onboard unit comprises:
at least one sensor deployed in an exhaust line of the vehicle for sensing the exhaust gas emissions by the vehicle;
a processor for computing a discount or surcharge on the base fuel price in real time based on the measured exhaust gas emissions; and
memory for storing the discount or surcharge on the base fuel price.

22. The system of claim 21, wherein the onboard unit comprises:
a display device for displaying the discount or surcharge computed on the base fuel price.

23. The system of claim 21, wherein the processor computes the discount or surcharge based on the exhaust gas emissions measured between consecutive fuel filling cycles.

24. The system of claim 23, wherein the processor computes a discount or surcharge on the base fuel price by comparing the exhaust gas emission value with a permissible standard exhaust gas emission value.

25. The system of claim 20, wherein the fuel station is configured for fetching the stored discount or surcharge value stored in the onboard unit of the vehicle in real time.

26. The system of claim 25, wherein the fuel station is configured for computing a final price of the fuel to be filled in the fuel tank by applying the fetched discount or surcharge value to the base fuel price.

27. The system of claim 21, wherein the processor computes the discount or surcharge on the base fuel price based on a preset rule, wherein the rule indicates percentage of discount or surcharge applicable on the base fuel price.
